(19) United States
(12) Patent Application Publication
(10) Pub. No.: US 2026/0073602 A1
(43) Pub. Date: Mar. 12, 2026

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Hideki IMAIZUMI, Tokyo (JP)

(73) Assignee: FUJIFILM Corporation, Tokyo (JP)

(21) Appl. No.: 19/315,894

(22) Filed: Sep. 2, 2025

(30) Foreign Application Priority Data
Sep. 10, 2024 (JP) 2024-156863

(51) Int. Cl. G06T 11/00; G06T 3/60; G06T 7/73

(52) U.S. Cl. CPC G06T 12/30; G06T 3/60; G06T 7/74; G06T 2207/10081; G06T 2207/30196; G06T 2210/41

(57) ABSTRACT

The image processing apparatus derives an inclination amount of a reference line on the basis of an optical image obtained by imaging a part used for deriving the reference line of a subject or information indicating an irradiation direction of a light beam emitted onto the reference line, and generates a tilt image which is a tomographic image of an inclined cross section inclined according to the inclination amount by tilting and rotating an axial cross section using a slice image.

### CROSS-REFERENCE TO RELATED APPLICATIONS

This application claims priority from Japanese Patent Application No. 2024-156863, filed on Sep. 10, 2024, the entire disclosure of which is incorporated herein by reference.

### BACKGROUND

### 1. Technical Field

The present disclosure relates to an image processing apparatus, an image processing method, and an image processing program.

### 2. Description of the Related Art

JP2012-024233A discloses an X-ray computed tomography (CT) apparatus that sets a reconstruction range of a tilt image at a desired tilt angle to include a part of interest of a subject on a scout image of the subject in a lateral direction.

### SUMMARY

In the technique disclosed in JP2012-024233A, it is necessary to capture the scout image in order to generate the tilt image. The scout image is also referred to as a scanogram. For example, in the imaging of the radiation image, in a case in which the imaging of the scout image can be omitted, an exposure dose to the subject can be reduced. In addition, in a case in which the imaging of the scout image can be omitted, the imaging time can also be shortened.

The present disclosure has been made in view of the above circumstances, and an object of the present disclosure is to provide an image processing apparatus, an image processing method, and an image processing program capable of generating a tilt image without capturing a scout image.

An image processing apparatus according to a first aspect is an image processing apparatus comprising a processor configured to perform image processing on a slice image obtained by imaging a subject with a tomographic imaging apparatus, in which the processor is configured to: derive an inclination amount of a reference line of the subject on the basis of an optical image obtained by imaging a part used for deriving the reference line or information indicating an irradiation direction of a light beam emitted onto the reference line; and generate a tilt image that is a tomographic image of an inclined cross section inclined according to the inclination amount by tilting and rotating an axial cross section using the slice image.

An image processing apparatus of a second aspect is the image processing apparatus of the first aspect, in which the light beam is emitted onto the reference line by inclining only the light beam among the light beam and a gantry included in the tomographic imaging apparatus.

An image processing apparatus of a third aspect is the image processing apparatus of the first or second aspect, in which the optical image includes a front image of the subject captured by an imaging apparatus installed at a position in front of the subject.

An image processing apparatus of a fourth aspect is the image processing apparatus of the third aspect, in which the optical image further includes a side image of the subject captured by an imaging apparatus installed at a position on a side of the subject.

An image processing apparatus of a fifth aspect is the image processing apparatus of the first or second aspect, in which the optical image includes an image captured by one imaging apparatus installed at a position including a plurality of parts used for deriving the reference line in an angle of view.

An image processing apparatus according to a sixth aspect is the image processing apparatus according to any one of the first to fifth aspects, in which the optical image includes an image captured in a state in which a part of the subject including a target part of the slice image is within an angle of view.

An image processing method according to a seventh aspect is executed by a processor of an image processing apparatus including the processor configured to perform image processing on a slice image obtained by imaging a subject with a tomographic imaging apparatus, the method comprising: deriving an inclination amount of a reference line of the subject on the basis of an optical image obtained by imaging a part used for deriving the reference line or information indicating an irradiation direction of a light beam emitted onto the reference line; and generating a tilt image that is a tomographic image of an inclined cross section inclined according to the inclination amount by tilting and rotating an axial cross section using the slice image.

An image processing program according to an eighth aspect causes a processor of an image processing apparatus, which includes the processor configured to perform image processing on a slice image obtained by imaging a subject with a tomographic imaging apparatus, to execute: deriving an inclination amount of a reference line of the subject on the basis of an optical image obtained by imaging a part used for deriving the reference line or information indicating an irradiation direction of a light beam emitted onto the reference line; and generating a tilt image that is a tomographic image of an inclined cross section inclined according to the inclination amount by tilting and rotating an axial cross section using the slice image.

According to the present disclosure, it is possible to generate a tilt image without capturing a scout image.

### BRIEF DESCRIPTION OF THE DRAWINGS

FIG. 1 is a schematic front view showing an example of a configuration of a tomographic imaging system.

FIG. 2 is a schematic side view showing the example of the configuration of the tomographic imaging system.

FIG. 3 is a diagram for describing an angle of view of an imaging apparatus installed at a position in front of a subject.

FIG. 4 is a diagram for describing an angle of view of an imaging apparatus installed at a position on a side of the subject.

FIG. 5 is a block diagram showing an example of a hardware configuration of a console.

FIG. 6 is a diagram for describing a derivation model.

FIG. 7 is a diagram for describing an inclination amount of a reference line of a subject.

FIG. 8 is a block diagram showing an example of a functional configuration of a console according to a first embodiment.

FIG. 9 is a flowchart showing an example of tilt image generation processing according to the first embodiment.

FIG. 10 is a schematic front view showing an example of a configuration of a tomographic imaging system according to a modification example.

FIG. 11 is a diagram for describing an irradiation direction of a light beam.

FIG. 12 is a block diagram showing an example of a functional configuration of a console according to a second embodiment.

FIG. 13 is a flowchart showing an example of tilt image generation processing according to the second embodiment.

### DETAILED DESCRIPTION

Hereinafter, exemplary embodiments for implementing the technique of the present disclosure will be described in detail with reference to the drawings.

### First Embodiment

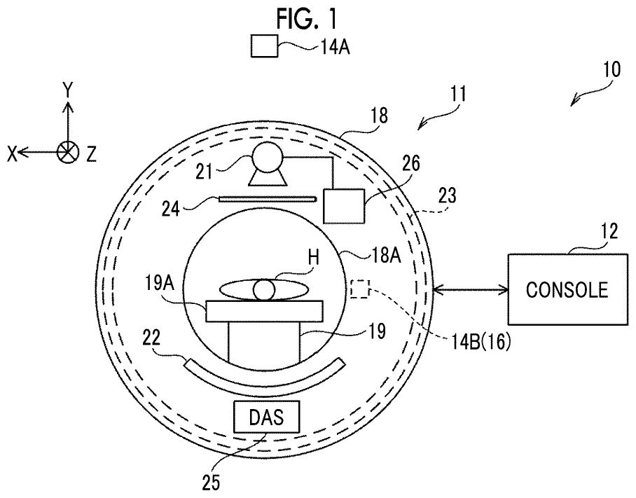

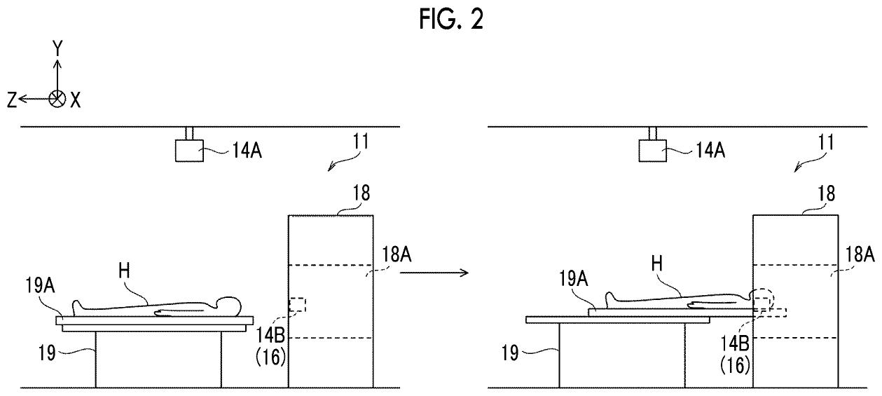

First, a configuration of a tomographic imaging system 10 according to the present embodiment will be described with reference to FIGS. 1 and 2. As shown in FIG. 1, the tomographic imaging system 10 comprises a CT apparatus 11, a console 12, an imaging apparatus 14A, and an imaging apparatus 14B. In the following, in a case where the imaging apparatus 14A and the imaging apparatus 14B are collectively referred to, the alphabet at the end of the reference numeral is omitted and referred to as an imaging apparatus 14. The CT apparatus 11 is an example of a tomographic imaging apparatus according to the disclosed technology. The console 12 is an example of an image processing apparatus comprising a processor that performs image processing on a slice image obtained by imaging a subject with a tomographic imaging apparatus according to the disclosed technology.

The CT apparatus 11 images the subject H using X-rays, which is an example of radiation, to obtain a slice image of the subject H. In the present embodiment, an example of a form in which the head is applied as the target part of the slice image captured by the CT apparatus 11 will be described. That is, the CT apparatus 11 captures a head CT image of the subject H. In addition, in the present embodiment, a case in which the slice image is a tomographic image representing an axial cross section of the subject H will be described as an example.

The CT apparatus 11 includes a gantry 18 and an examination table device 19. FIG. 1 is a front view of the gantry 18 and the examination table device 19, and FIG. 2 is a side view of the gantry 18 and the examination table device 19. The examination table device 19 includes a top plate 19A on which the subject H can be placed in a decubitus posture. In the following description, a body axis direction of the subject H (that is, a longitudinal direction of the top plate 19A) is referred to as a Z-axis direction, a width direction of the subject H orthogonal to the Z-axis direction (that is, a lateral direction of the top plate 19A) is referred to as an X-axis direction, and a height direction of the subject H (that is, a vertical direction) is referred to as a Y-axis direction. The top plate 19A is movable in the Z-axis direction in a state of being kept horizontal. The gantry 18 has an annular shape as a whole, and a circular opening part 18A having a diameter larger than a width of the top plate 19A is formed in the center. As shown in FIG. 2, in a case of the imaging, the top plate 19A on which the subject H is placed is moved in the Z-axis direction with respect to the gantry 18 to enter the opening part 18A. The imaging is performed while the top plate 19A is moved with respect to the gantry 18.

A radiation source 21, a radiation detector 22, and a frame 23 are disposed inside the gantry 18. The radiation source 21 emits radiation toward the subject H. The radiation detector 22 detects radiation transmitted through the subject H. The radiation transmitted through the subject H is attenuated by interaction (for example, absorption and scattering of the radiation) with structures such as organs and bones in the body of the subject H. The structures each have an attenuation coefficient for radiation peculiar to the structures, and the radiation transmitted through the structures carries information reflecting the physical properties of the structures. The radiation detector 22 detects radiation in which physical properties of the structures in the body of the subject H are reflected. The radiation detector 22 has a detection surface in which detection elements are two-dimensionally arranged, and outputs a detection signal for each detection element. Therefore, the radiation detector 22 can detect the radiation at each transmission position transmitted through the structure of the subject H. In addition, the radiation detector 22 has a substantially arc shape in accordance with a curvature of the gantry 18, and the detection surface is also curved.

The radiation source 21 and the radiation detector 22 are disposed at positions facing each other in the gantry 18 and are rotated about the Z axis while maintaining the facing posture. The frame 23 has an annular shape and supports the radiation source 21 and the radiation detector 22 to be rotatable. In a case of imaging, the gantry 18 acquires detection signals by the radiation detector 22 at a plurality of positions in a circumferential direction about the Z axis corresponding to the body axis of the subject H while rotating the radiation source 21 and the radiation detector 22 about the subject H on the top plate 19A. In a case of the imaging, the top plate 19A is also moved in the Z-axis direction in synchronization with the rotation of the radiation source 21 and the radiation detector 22.

A data acquisition system (DAS) 25 collects the detection signals output by the radiation detector 22, generates the projection data at each position about the Z axis based on the collected detection signals, and outputs the generated projection data to the console 12. As a result, the console 12 acquires the projection data of the radiation at each position about the body axis of the subject H.

An irradiation field limiter 24 (also referred to as a collimator) that limits an irradiation field of the radiation is disposed in front of the radiation source 21 in an irradiation direction. The irradiation field limiter 24 has an irradiation opening of which a contour is defined by a plurality of shielding plates that shield the radiation, and a size of the irradiation opening can be changed by moving the shielding plates. A voltage is supplied to the radiation source 21 from a high-voltage generator 26. The radiation source 21 and the radiation detector 22 are electrically connected to the frame 23 by a slip ring method, and, for example, power supply, transmission and reception of data, and the like are performed via the slip ring. The slip ring method connection makes it possible to perform helical scan imaging in which the radiation source 21 and the radiation detector 22 are rotated in one direction while performing imaging without reversing the rotation direction.

The console 12 controls the radiation source 21 and the radiation detector 22 via a control device (not shown) provided in the gantry 18. Imaging conditions of the CT apparatus 11 are set via the operation from the console 12. The imaging condition includes irradiation conditions of the radiation from the radiation source 21, an imaging range, and the like. The irradiation condition of the radiation includes a tube voltage (unit: kV) applied to the radiation source 21, a tube current (unit: mA), and an irradiation time (unit: msec) of the radiation. The imaging range is adjusted, for example, by changing the size of the irradiation opening of the irradiation field limiter 24 in the X-Z plane, and is adjusted by changing the movement range of the top plate 19A in the Z-axis direction.

The imaging apparatus 14 is a camera that can capture a color image of Red (R), Green (G), and Blue (B) by detecting reflected light of the subject H. The imaging apparatus 14 has an optical system such as a lens and an imaging element such as a charge coupled device (CCD) image sensor, and captures an image of the subject H on the examination table device 19.

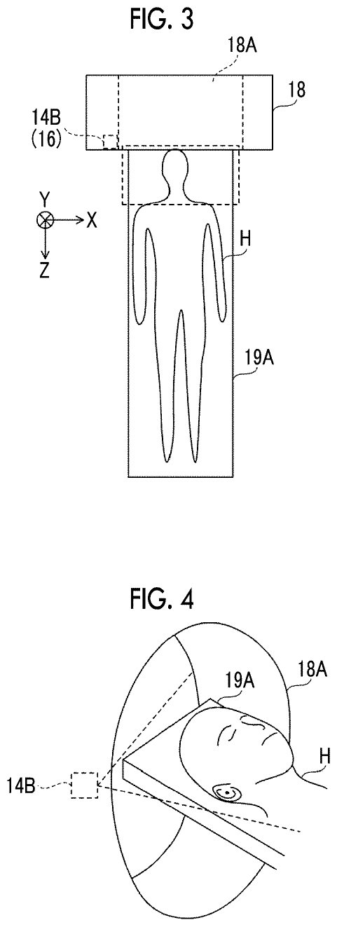

The imaging apparatus 14A is installed on a ceiling, which is a position in front of the subject H placed on the top plate 19A. As shown in FIG. 3, in a case where the subject H is moved to the entrance of the opening part 18A before the CT apparatus 11 starts capturing the slice image, the imaging apparatus 14A captures an image in a state in which a part of the subject H including the head, which is a target part of the slice image, is within the angle of view, instead of the whole body of the subject H. In the example of FIG. 3, a broken line rectangle indicates an angle of view of the imaging apparatus 14A, and the image captured by the imaging apparatus 14A includes a portion above the shoulder, which is a part of the subject H including the head. Therefore, the image captured by the imaging apparatus 14A is in a state in which a part used for deriving a reference line of the subject H, which will be described later, is enlarged, compared to an image in which the whole body of the subject H is captured. Hereinafter, a front image of the subject H captured by the imaging apparatus 14A is referred to as a “first optical image”.

In addition, the imaging apparatus 14B is installed at a position on a side of the subject H. In the present embodiment, the imaging apparatus 14B is installed on the right side of the subject H near the entrance where the subject H enters the opening part 18A. As shown in FIG. 4, the imaging apparatus 14B images the right side surface of the head of the subject H in a case where the subject H is moved to the entrance of the opening part 18A before the CT apparatus 11 starts capturing the slice image. In the example of FIG. 4, a straight line of a broken line indicates the angle of view of the imaging apparatus 14B. Hereinafter, a side image of the subject H captured by the imaging apparatus 14B is referred to as a “second optical image”. The imaging apparatus 14B may be installed at a position where the left side surface of the head of the subject H can be imaged, or may be installed at each of a position where the right side surface of the head of the subject H can be imaged and a position where the left side surface of the head of the subject H can be imaged. The first optical image and the second optical image are examples of an optical image according to the disclosed technology.

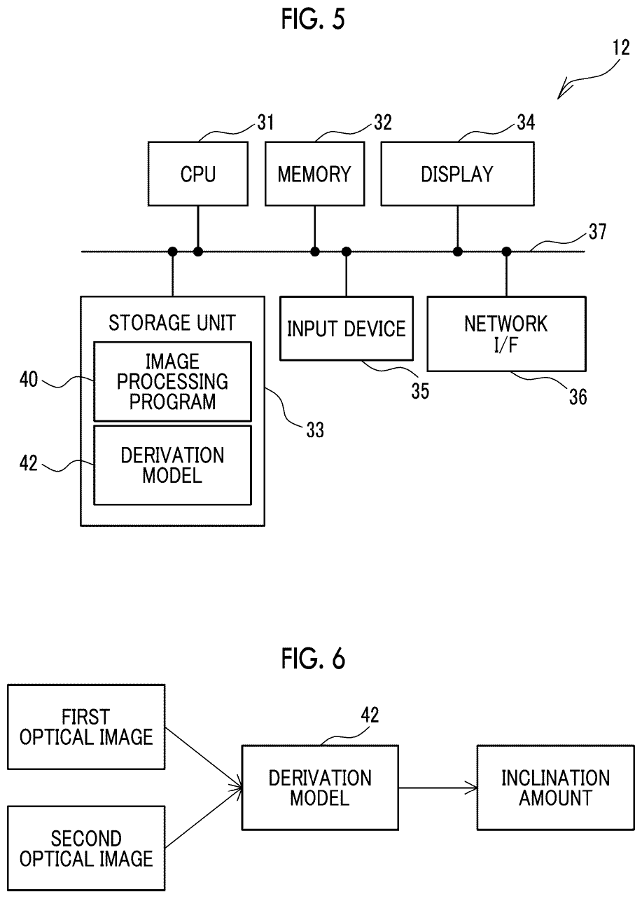

Subsequently, a hardware configuration of the console 12 according to the present embodiment will be described with reference to FIG. 5. Examples of the console 12 include a computer, such as a personal computer or a server computer. As shown in FIG. 5, the console 12 includes a central processing unit (CPU) 31, a memory 32 as a temporary storage area, and a non-volatile storage unit 33. In addition, the console 12 includes a display 34 such as a liquid crystal display, an input device 35 such as a keyboard and a mouse, and a network interface (I/F) 36 connected to the CT apparatus 11 and the imaging apparatus 14. The CPU 31, the memory 32, the storage unit 33, the display 34, the input device 35, and the network I/F 36 are connected to a bus 37. The CPU 31 is an example of a processor according to the disclosed technology.

The storage unit 33 is implemented using a hard disk drive (HDD), a solid state drive (SSD), a flash memory, or the like. The storage unit 33 as a storage medium stores an image processing program 40. The CPU 31 reads out the image processing program 40 from the storage unit 33, loads the image processing program 40 in the memory 32, and executes the loaded image processing program 40.

In addition, the storage unit 33 stores a derivation model 42 used for deriving the inclination amount of the reference line of the subject H. As shown in FIG. 6, the derivation model 42 is a model that receives the first optical image and the second optical image of the subject H as inputs, detects the reference line of the subject H from the first optical image and the second optical image, and outputs the detected inclination amount of the reference line of the subject H. The derivation model 42 is a trained model obtained in advance by machine learning using the first optical image and the second optical image as learning data, and the reference line of the subject H and the inclination amount of the reference line appearing in the first optical image and the second optical image.

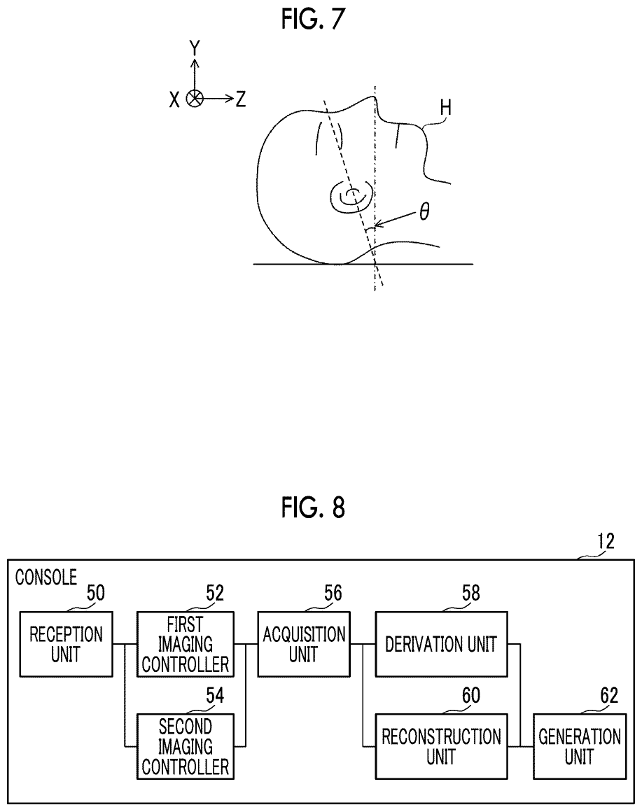

The reference line is, for example, an orbit-external auditory canal line that connects the center of the orbit and the center of the external auditory canal, an orbit-superior external auditory canal line that connects the superior orbit and the center of the external auditory canal, or a German horizontal line that connects the inferior orbit and the superior edge of the external auditory canal. As shown in FIG. 7, in the present embodiment, a case where an angle θ formed by the reference line and the Y axis in the Y-Z plane is applied as the inclination amount of the reference line of the subject H will be described as an example. In the example of FIG. 7, the reference line is indicated by a broken line. The first optical image shows at least an eye, which is a part used for deriving a reference line of the subject H, and the second optical image shows at least an ear, which is a part used for deriving a reference line of the subject H.

The gantry 18 does not include an inclination mechanism that is inclined about the X axis. The console 12 according to the present embodiment has a function of generating a tilt image which is a tomographic image of an inclined cross section inclined by tilting and rotating an axial cross section using a slice image. The tilting and rotating means rotation about the X axis.

Subsequently, a functional configuration of the console 12 will be described with reference to FIG. 8. As shown in FIG. 8, the console 12 includes a reception unit 50, a first imaging controller 52, a second imaging controller 54, an acquisition unit 56, a derivation unit 58, a reconstruction unit 60, and a generation unit 62. The CPU 31 executes the image processing program 40 to function as the reception unit 50, the first imaging controller 52, the second imaging controller 54, the acquisition unit 56, the derivation unit 58, the reconstruction unit 60, and the generation unit 62.

The reception unit 50 receives an instruction to start imaging, which is input by a user such as a technician via the input device 35. The user moves the subject H to the imaging start position by sliding the top plate 19A in the Z-axis direction after the subject H lies on the top plate 19A. Then, the user inputs an instruction to start imaging via the input device 35. The imaging start position is a position where the head of the subject H is within the angle of view of the imaging apparatus 14A and the imaging apparatus 14B. The CPU 31 may perform control of displaying a moving image captured by the imaging apparatus 14A and a moving image captured by the imaging apparatus 14B on the display 34 at a predetermined frame rate. Accordingly, the user can move the subject H to the imaging start position while checking the moving image displayed on the display 34.

The first imaging controller 52 controls the imaging apparatus 14A to capture the first optical image. In addition, the first imaging controller 52 controls the imaging apparatus 14B to capture the second optical image.

The second imaging controller 54 performs imaging of a helical scan method by moving the top plate 19A and controlling the radiation source 21 and the radiation detector 22 in accordance with the imaging conditions.

The acquisition unit 56 acquires the first optical image and the second optical image captured by the imaging apparatus 14A and the imaging apparatus 14B under the control of the first imaging controller 52. In addition, the acquisition unit 56 acquires the projection data output by the radiation detector 22 under the control of the second imaging controller 54 from the DAS 25.

The derivation unit 58 derives the inclination amount of the reference line of the subject H based on the first optical image and the second optical image acquired by the acquisition unit 56 and the derivation model 42. Specifically, the derivation unit 58 inputs the first optical image and the second optical image to the derivation model 42. The derivation model 42 detects the reference line of the subject H from the input first optical image and second optical image, and outputs the detected inclination amount of the reference line of the subject H. Accordingly, the derivation unit 58 derives the inclination amount of the reference line of the subject H.

The CPU 31 may perform control of displaying the reference line of the subject H detected by the derivation model 42 on the display 34 in a state of being superimposed on at least one of the first optical image or the second optical image. The user may check the reference line of the subject H displayed on the display 34 and then input the instruction to start the imaging of the helical scan method. In addition, the user may correct the reference line of the subject H displayed on the display 34 via the input device 35. In this case, the derivation unit 58 may derive the inclination amount of the corrected reference line.

The reconstruction unit 60 generates a slice image, which is a tomographic image representing the axial cross section, by reconstructing an image based on the projection data acquired by the acquisition unit 56. The image reconstruction based on the projection data is performed by, for example, a filtered back projection method.

The generation unit 62 generates a tilt image, which is a tomographic image of an inclined cross section inclined in accordance with the inclination amount derived by the derivation unit 58 by tilting and rotating the axial cross section using the slice image generated by the reconstruction unit 60. For example, the generation unit 62 generates a tilt image representing an inclined cross section inclined by rotating the slice image by the inclination amount about the X axis by performing the coordinate conversion using the rotation determinant corresponding to the inclination amount derived by the derivation unit 58.

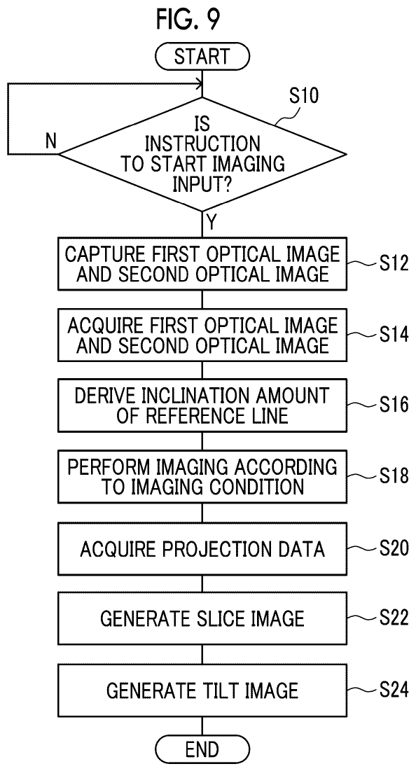

Subsequently, the operation and effect of the console 12 will be described with reference to FIG. 9. The CPU 31 executes the image processing program 40 to execute the tilt image generation processing shown in FIG. 9.

In step S10 of FIG. 9, the reception unit 50 waits until the user inputs the instruction to start imaging via the input device 35. In a case where the reception unit 50 receives the instruction to start imaging, the determination in step S10 is affirmative, and the processing proceeds to step S12.

In step S12, the first imaging controller 52 controls the imaging apparatus 14A to capture the first optical image and controls the imaging apparatus 14B to capture the second optical image. In step S14, the acquisition unit 56 acquires the first optical image and the second optical image captured by the imaging apparatus 14A and the imaging apparatus 14B by the control of step S12.

In step S16, as described above, the derivation unit 58 derives the inclination amount of the reference line of the subject H based on the first optical image and the second optical image acquired in step S14 and the derivation model 42. In step S18, the second imaging controller 54 performs the helical scan imaging by controlling the movement of the top plate 19A, the radiation source 21, and the radiation detector 22 in accordance with the imaging conditions.

In step S20, the acquisition unit 56 acquires the projection data output by the radiation detector 22 under the control of step S18 from the DAS 25. In step S22, the reconstruction unit 60 generates a slice image, which is a tomographic image representing the axial cross section, by reconstructing the image based on the projection data acquired in step S20.

In step S24, as described above, the generation unit 62 generates a tilt image, which is a tomographic image of the inclined cross section inclined in accordance with the inclination amount derived in step S16 by tilting and rotating the axial cross section using the slice image generated in step S22. In a case in which the processing of step S24 ends, the tilt image generation processing ends.

As described above, according to the present embodiment, the reference line of the subject H and the inclination amount of the reference line are derived from the first optical image and the second optical image, and the tilt image corresponding to the inclination amount is generated. Therefore, it is possible to generate the tilt image without capturing the scout image. As a result, the exposure dose to the subject can be reduced as compared with a case in which the scout image is captured. In addition, it is possible to shorten the imaging time as compared with a case in which the scout image is captured.

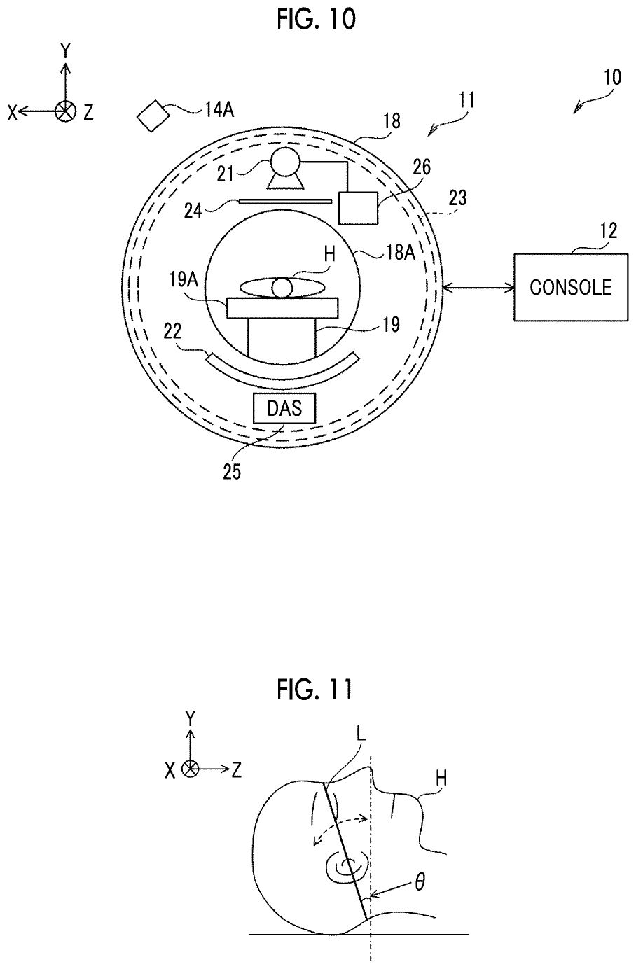

In the first embodiment, a case where the derivation unit 58 derives the inclination amount of the reference line using the first optical image and the second optical image captured by the two imaging apparatuses 14A and 14B has been described, but the disclosed technology is not limited to this aspect. For example, as shown in FIG. 10, the derivation unit 58 may derive the inclination amount of the reference line using the optical image captured by one imaging apparatus 14A installed at a position including a plurality of parts used for the derivation of the reference line in the angle of view. In the example of FIG. 10, the imaging apparatus 14A is installed at a position inclined toward the side surface side of the subject H about the Z axis as compared with the example of FIG. 1, and the eye and the ear used for the derivation of the reference line are included in the angle of view of the imaging apparatus 14A.

### Second Embodiment

First, a configuration of a tomographic imaging system 10 according to the present embodiment will be described with reference to FIGS. 1 and 2. The same components as those of the tomographic imaging system 10 according to the first embodiment are denoted by the same reference numerals, and the description thereof will be omitted.

As shown in FIG. 1, the tomographic imaging system 10 comprises a light source 16 instead of the imaging apparatus 14B according to the first embodiment. The light source 16 is installed at a position on a side of the subject H. In the present embodiment, the light source 16 is installed on the right side of the subject H near the entrance where the subject H enters the opening part 18A. The light source 16 emits a light beam to the right side surface of the head of the subject H in a case where the subject H is moved to the entrance of the opening part 18A before the CT apparatus 11 starts capturing the slice image. Examples of the light beam emitted from the light source 16 include a red light emitting diode (LED) laser beam. The light source 16 may be installed at a position where the left side surface of the head of the subject H can be irradiated with the light beam, or may be installed at each of a position where the right side surface of the head of the subject H can be irradiated with the light beam and a position where the left side surface of the head of the subject H can be irradiated with the light beam.

As shown in FIG. 11, an irradiation direction of the light beam L emitted from the light source 16 is adjustable in the Y-Z plane. The light source 16 is rotated by a drive mechanism such as an actuator, so that the irradiation direction of the light beam L can be changed. The user inclines the light beam L emitted to the side surface of the subject H about the Z axis by inputting an angle through the dial or the input device 35. The console 12 acquires information indicating the irradiation direction of the light beam L from the drive mechanism of the light source 16. In the present embodiment, a case where an angle θ formed by the light beam L and the Y axis in the Y-Z plane is applied as the information indicating the irradiation direction of the light beam L will be described as an example. That is, in a case where the user adjusts the irradiation direction of the light beam L such that the light beam L and the reference line of the subject H match, the information indicating the irradiation direction of the light beam L represents the inclination amount of the reference line of the subject H. The user inputs an instruction to start imaging after adjusting the irradiation direction of the light beam L such that the light beam L and the reference line of the subject H match.

As described above, the gantry 18 does not include the inclination mechanism that is inclined about the X axis. That is, only the light beam L is inclined in the light beam L and the gantry 18 of the CT apparatus 11, so that the light beam L is emitted to the reference line.

Since the hardware configuration of the console 12 according to the present embodiment is the same as that of the console 12 according to the first embodiment, the description thereof will be omitted. In the present embodiment, the storage unit 33 may not store the derivation model 42.

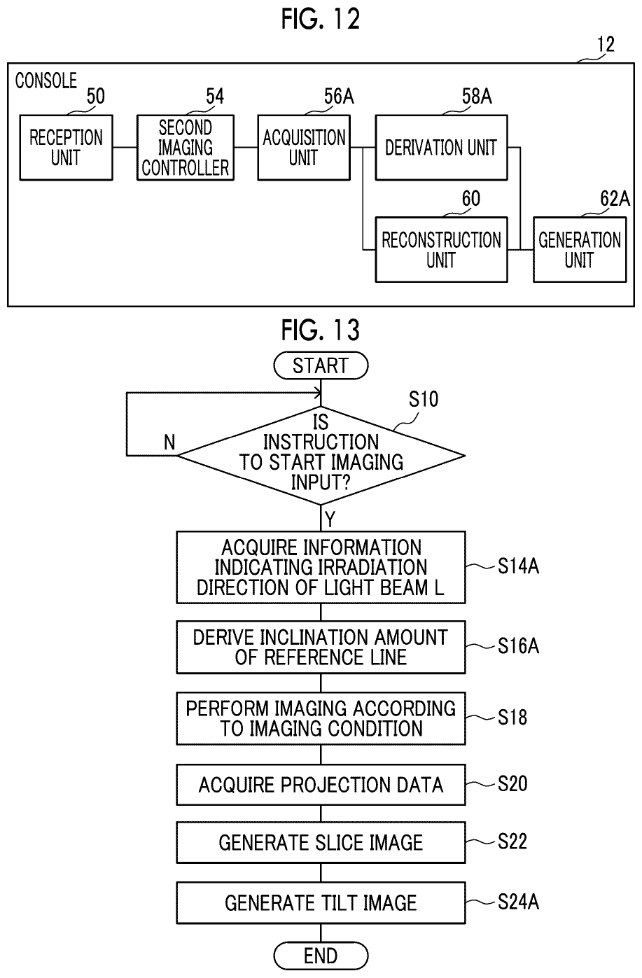

Subsequently, a functional configuration of the console 12 will be described with reference to FIG. 12. The functional units having the same functions as the console 12 according to the first embodiment are denoted by the same reference numerals, and the description thereof will be omitted. As shown in FIG. 12, the console 12 includes the reception unit 50, the second imaging controller 54, the acquisition unit 56A, the derivation unit 58A, the reconstruction unit 60, and the generation unit 62A. The CPU 31 executes the image processing program 40 to function as the reception unit 50, the second imaging controller 54, the acquisition unit 56A, the derivation unit 58A, the reconstruction unit 60, and the generation unit 62A.

The acquisition unit 56A acquires the projection data output by the radiation detector 22 under the control of the second imaging controller 54 from the DAS 25. In addition, the acquisition unit 56A acquires information indicating the irradiation direction of the light beam L from the drive mechanism of the light source 16.

The derivation unit 58A derives the inclination amount of the reference line of the subject H based on the information acquired by the acquisition unit 56A. In the present embodiment, the derivation unit 58A derives the information acquired by the acquisition unit 56A as the inclination amount of the reference line of the subject H. The information indicating the irradiation direction of the light beam L may be the rotation amount of the light source 16. In this case, the derivation unit 58A may derive the inclination amount of the reference line by converting the rotation amount of the light source 16 into the inclination amount of the reference line.

The generation unit 62A generates a tilt image, which is a tomographic image of an inclined cross section inclined in accordance with the inclination amount derived by the derivation unit 58A by tilting and rotating the axial cross section using the slice image generated by the reconstruction unit 60, in the same manner as the generation unit 62 according to the first embodiment.

Subsequently, the operation and effect of the console 12 will be described with reference to FIG. 13. The CPU 31 executes the image processing program 40 to execute the tilt image generation processing shown in FIG. 13. In FIG. 13, steps executing the same process as those in FIG. 9 are denoted by the same step numbers as those in FIG. 9, and the description thereof will be omitted. As shown in FIG. 13, in the tilt image generation processing according to the present embodiment, step S12 of the tilt image generation processing according to the first embodiment is not executed, and steps S14A, S16A, and S24A are executed instead of steps S14, S16, and S24.

In step S14A, the acquisition unit 56A acquires the information indicating the irradiation direction of the light beam L from the drive mechanism of the light source 16. In step S16A, the derivation unit 58A derives the inclination amount of the reference line of the subject H based on the information acquired in step S14A. In step S24A, the generation unit 62A generates a tilt image, which is a tomographic image of an inclined cross section inclined in accordance with the inclination amount derived in step S16A by tilting and rotating the axial cross section using the slice image generated in step S22.

As described above, according to the present embodiment, the inclination amount of the reference line of the subject H is derived from the information indicating the irradiation direction of the light beam L, and the tilt image corresponding to the inclination amount is generated. Therefore, it is possible to generate the tilt image without capturing the scout image.

In addition, in the second embodiment, the tomographic imaging system 10 may comprise the imaging apparatus 14B as in the first embodiment. In this case, the derivation unit 58A may derive the inclination amount of the reference line of the subject H using the light beam L captured in the second optical image as the reference line. In addition, in this case, the CPU 31 may control the irradiation direction of the light beam L such that the light beam L and the reference line of the subject H match while referring to the second optical image.

In addition, at least one of the functional units provided in the console 12 in each of the above-described embodiments may be provided in another device such as a control device provided in the gantry 18.

In addition, in each of the above-described embodiments, a case where the CT apparatus 11 is applied as the tomographic imaging apparatus has been described, but the disclosed technology is not limited to this aspect. For example, a magnetic resonance imaging (MRI) apparatus may be applied as the tomographic imaging apparatus. In this case as well, it is possible to generate the tilt image without capturing the scout image. As a result, it is possible to shorten the imaging time as compared with a case in which the scout image is captured.

In addition, in each of the above-described embodiments, each process is executed by any computer. In addition, any computer may execute these processes by a processor as hardware, a program as software, or a combination thereof. In that case, the processor is configured to execute various types of processing in each of the above-described embodiments in cooperation with the program, and can function as each unit or each means in each of the above-described embodiments. In addition, the execution order of the processing by the processor is not limited to the order described above and may be changed as appropriate. Any computer may be a general-purpose computer, a computer for a specific use, a workstation, or another system capable of executing each process.

The processor may be configured by one or a plurality of hardware, and the type of hardware is not limited. For example, the processor may be configured by hardware such as a central processing unit (CPU), a micro processing unit (MPU), a programmable logic device such as a field programmable gate array (FPGA), a dedicated circuit for executing specific processing such as an application specific integrated circuit (ASIC), a graphic processing unit (GPU), or a neural processing unit (NPU). In addition, the types of hardware may be a combination of different types of hardware. In a case where a plurality of hardware are configured to execute one or a plurality of processes of a certain processor, the plurality of hardware may be present in devices physically separated from each other, or may be present in the same device. In addition, in any of the embodiments, the order of each processing by the processor is not limited to the above order, and may be changed as appropriate. The hardware is configured by an electric circuit (circuitry) in which circuit elements such as semiconductor elements are combined.

Furthermore, the program may be software such as firmware or a microcode. In addition, the program may be, for example, a program module group, and each function thereof may be realized by a processor configured to execute each function. The program may be a program code or a plurality of code segments stored in one or a plurality of non-transitory computer-readable media (for example, a storage medium or other storage). The program may be stored in a plurality of non-transitory computer-readable media existing in devices physically separated from each other. The program code or code segment may represent any combination of a procedure, a function, a subprogram, a routine, a subroutine, a module, a software package, a class, or an instruction, a data structure, or a program statement. The program code or code segment may be connected to another code segment or a hardware circuit by transmitting and receiving information, data, an argument, a parameter, or a content of a memory.

In each of the above-described embodiments, the aspect has been described in which the image processing program 40 is stored (installed) in the storage unit 33 in advance, but the technology of the present disclosure is not limited to this. The image processing program 40 may be provided in a form recorded in a recording medium, such as a compact disc read-only memory (CD-ROM), a digital versatile disc read-only memory (DVD-ROM), and a universal serial bus (USB) memory. Further, the image processing program 40 may also be downloaded from an external device via the network. In addition, the image processing program 40 can be provided as a program product. The program product includes products in all aspects for providing a program. For example, the program product includes a program provided through a network such as the Internet, and a non-transitory computer readable recording medium such as a CD-ROM or a DVD in which the program is stored.

What is claimed is:

1. An image processing apparatus comprising:
a processor configured to perform image processing on a slice image obtained by imaging a subject with a tomographic imaging apparatus,
wherein the processor is configured to:
derive an inclination amount of a reference line of the subject on the basis of an optical image obtained by imaging a part used for deriving the reference line or information indicating an irradiation direction of a light beam emitted onto the reference line; and
generate a tilt image that is a tomographic image of an inclined cross section inclined according to the inclination amount by tilting and rotating an axial cross section using the slice image.

2. The image processing apparatus according to claim 1,
wherein the light beam is emitted onto the reference line by inclining only the light beam among the light beam and a gantry included in the tomographic imaging apparatus.

3. The image processing apparatus according to claim 1,
wherein the optical image includes a front image of the subject captured by an imaging apparatus installed at a position in front of the subject.

4. The image processing apparatus according to claim 3,
wherein the optical image further includes a side image of the subject captured by an imaging apparatus installed at a position on a side of the subject.

5. The image processing apparatus according to claim 1,
wherein the optical image includes an image captured by one imaging apparatus installed at a position including a plurality of parts used for deriving the reference line in an angle of view.

6. The image processing apparatus according to claim 1,
wherein the optical image includes an image captured in a state in which a part of the subject including a target part of the slice image is within an angle of view.

7. An image processing method executed by a processor of an image processing apparatus including the processor configured to perform image processing on a slice image obtained by imaging a subject with a tomographic imaging apparatus, the method comprising:
deriving an inclination amount of a reference line of the subject on the basis of an optical image obtained by imaging a part used for deriving the reference line or information indicating an irradiation direction of a light beam emitted onto the reference line; and
generating a tilt image that is a tomographic image of an inclined cross section inclined according to the inclination amount by tilting and rotating an axial cross section using the slice image.

8. A non-transitory computer-readable storage medium storing an image processing program for causing a processor of an image processing apparatus, which includes the processor configured to perform image processing on a slice image obtained by imaging a subject with a tomographic imaging apparatus, to execute:
deriving an inclination amount of a reference line of the subject on the basis of an optical image obtained by imaging a part used for deriving the reference line or information indicating an irradiation direction of a light beam emitted onto the reference line; and
generating a tilt image that is a tomographic image of an inclined cross section inclined according to the inclination amount by tilting and rotating an axial cross section using the slice image.
